(19) United States
(12) Patent Application Publication
(10) Pub. No.: US 2023/0057279 A1
(43) Pub. Date: Feb. 23, 2023

(54) Debris Collection Device

(71) Applicant: David Gardner, Olympia, WA (US)

(72) Inventor: David Gardner, Olympia, WA (US)

(21) Appl. No.: 17/404,041

(22) Filed: Aug. 17, 2021

(51) Int. Cl. B65F 1/00; B65F 1/14; A01G 20/43

(52) U.S. Cl. CPC B65F 1/002; B65F 1/1452; A01G 20/43; B65F 2250/114; B65F 2240/138

(57) ABSTRACT

A debris collection device for collecting and transporting debris includes a shell, which defines an interior space. The shell is flexible and thus collapsible. The shell has a top, which is open for insertion of articles, such as debris, into the interior space. A pair of sleeves is engaged singly to and extends along opposed sides of the shell proximate to the top. Each of a pair of poles is selectively insertable into a respective sleeve so that opposed terminal sections of the pole protrude from the sleeve. The opposed terminal sections can be grasped in hands of user, positioning the user to lift the shell and the articles.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to collection devices and more particularly pertains to a new collection device for collecting and transporting debris. The present invention discloses a

### (2) Description of Related Art Including Information Disclosed Under 37 CFR 1.97 and 1.98

The prior art relates to collection devices. The prior art includes tubes with handles, and semispherical bags with handles. What is lacking in the prior art is a substantially cuboid shaped collapsible bag having a pair of poles along opposed side proximate to a top of the bag, wherein one opposed side can be position on a surface, allowing debris to be maneuvered into the bag. The poles act as handles. Lifting with the handles substantially closes the top.

### BRIEF SUMMARY OF THE INVENTION

An embodiment of the disclosure meets the needs presented above by generally comprising a shell, which defines an interior space. The shell is flexible and thus collapsible. The shell has a top, which is open so that the top is configured for insertion of articles, such as debris, into the interior space. A pair of sleeves is engaged singly to and extends along opposed sides of the shell proximate to the top. Each of a pair of poles is selectively insertable into a respective sleeve so that opposed terminal sections of the pole protrude from the sleeve. The opposed terminal sections are configured to be grasped in hands of user, positioning the user to lift the shell and the articles.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an open isometric perspective view of a debris collection device according to an embodiment of the disclosure.

FIG. 2 is a closed isometric perspective view of an embodiment of the disclosure.

FIG. 3 is a side view of an embodiment of the disclosure.

FIG. 4 is a cross-sectional view of an embodiment of the disclosure.

FIG. 5 is an end view of an embodiment of the disclosure.

FIG. 6 is a flow diagram for a method utilizing an embodiment of the disclosure.

### DETAILED DESCRIPTION OF THE INVENTION

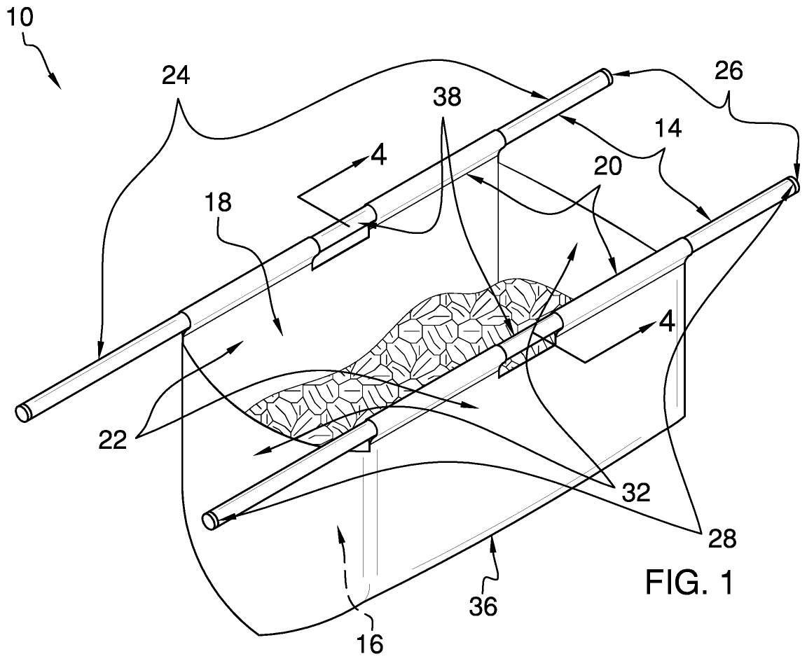

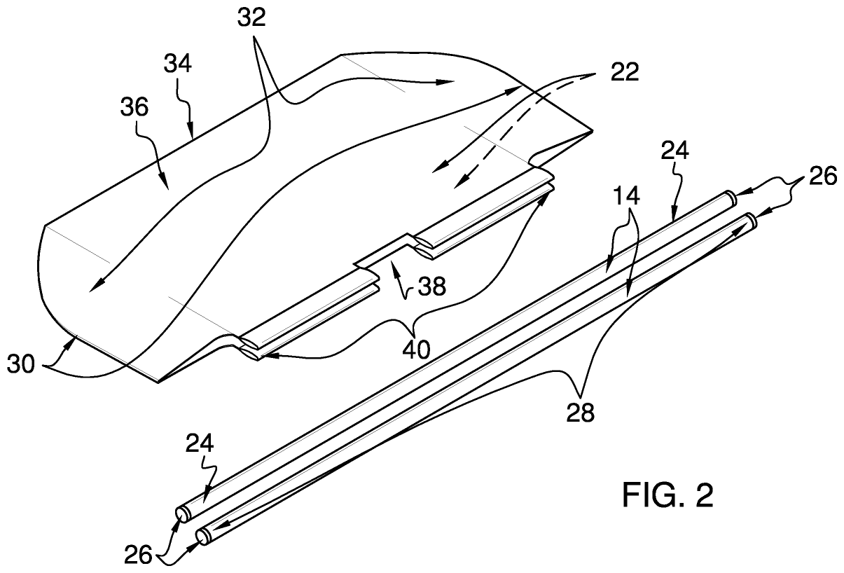

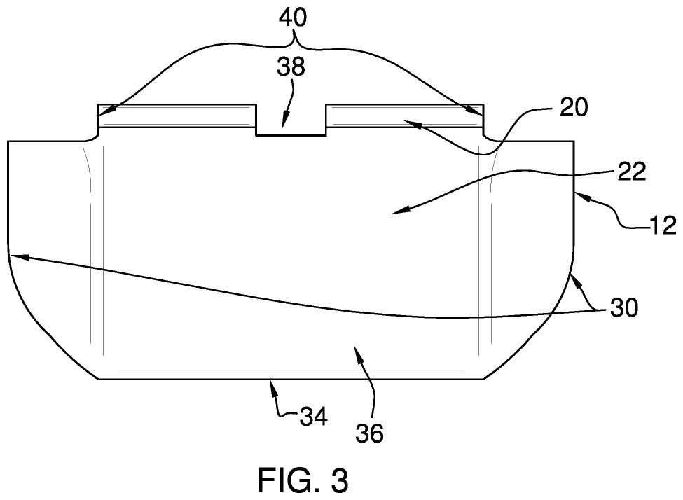

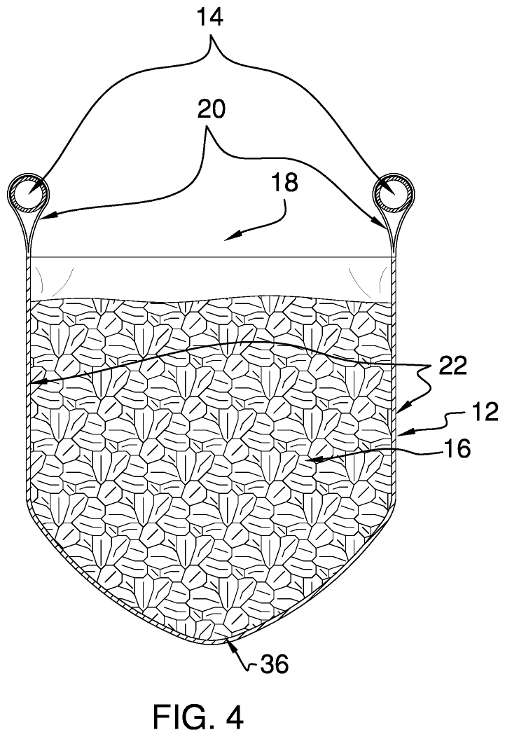

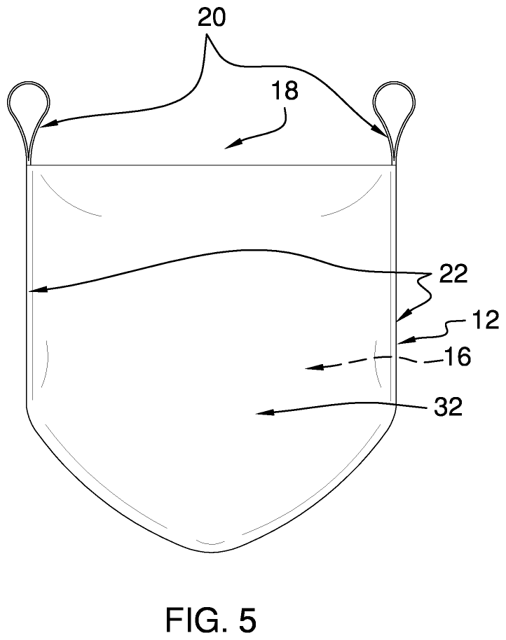

With reference now to the drawings, and in particular to FIGS. 1 through 6 thereof, a new collection device embodying the principles and concepts of an embodiment of the disclosure and generally designated by the reference numeral 10 will be described.

As best illustrated in FIGS. 1 through 6, the debris collection device 10 generally comprises a shell 12 and a pair of poles 14. The shell 12 defines an interior space 16. The shell 12 is flexible and thus collapsible. The shell 12 comprises one or more of nylon, canvas, elastomer, and the like. The shell 12 has a top 18, which is open, so that the top 18 is configured for insertion of articles into the interior space 16. A pair of sleeves 20 is engaged singly to and extends along opposed sides 22 of the shell 12 proximate to the top 18.

Each of the pair of poles 14 is selectively insertable into a respective sleeve 20 so that opposed terminal sections 24 of the pole 14 protrude from the sleeve 20. Each of a set of caps 26 is engaged to an opposed terminus 28 of respective pole 14 so that each opposed terminus 28 of each pole 14 is capped. The opposed terminal sections 24 are configured to be grasped in hands of user, positioning the user to lift the shell 12 and the articles. The debris collection device 10 is anticipated to be of particular use in collecting and transporting debris, such as yard waste, although the present invention also anticipates the debris collection device 10 finding utility in collection and transportation of other articles, such as grain, snow, sand, and the like.

Each of a pair of first creases 30 is positioned in a respective opposed end 32 of the shell 12 substantially equally distant from the opposed sides 22 so that the opposed ends 32 are foldable. A second crease 34 is positioned in a bottom 36 of the shell 12 substantially equally distant from the opposed sides 22 so that the bottom 36 is foldable. The bottom 36 may be arcuate and the opposed ends 32 may be arcuate proximate to the bottom 36 so that the shell 12 is substantially U-shaped when viewed from a respective opposed end 32. The present invention also anticipates the shell 12 being alternatively shaped, such as cuboid shaped, disc shaped, and the like.

Each of a pair of cutouts 38 is positioned in a respective sleeve 20 substantially equally distant from opposed endpoints 40 of the respective sleeve 20. The cutout 38 is configured to facilitate insertion of a respective pole 14 through the respective sleeve 20.

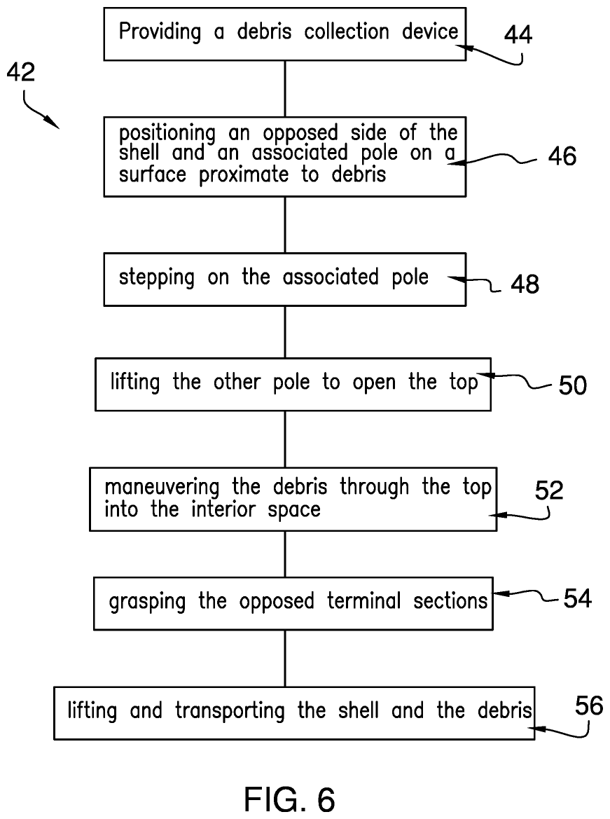

In use, the debris collection device 10 enables a debris collection method 42. As shown in FIG. 6, a first step 44 of the method is providing a debris collection device 10 according to the specification above. A second step 46 of the method 42 is positioning a respective opposed side 22 of the shell 12 on a surface proximate to debris so that an associated pole 14 is adjacent to the surface and the debris. A third step 48 of the method 42 is stepping on the associated pole 14. A fourth step 50 of the method 42 is lifting the other pole 14 to open the top 18. A fifth step 52 of the method 42 is maneuvering the debris through the top 18 into the interior space 16. A sixth step 54 of the method 42 is grasping the opposed terminal sections 24. A seventh step 56 of the method 42 is lifting and transporting the shell 12 and the debris.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A debris collection device comprising:
a shell defining an interior space, the shell being flexible, such that the shell is collapsible, the shell having a top, the top being open, wherein the top is configured for insertion of articles into the interior space;
a pair of sleeves engaged singly to and extending along opposed sides of the shell proximate to the top; and
a pair of poles, each pole being selectively insertable into a respective sleeve, such that opposed terminal sections of the pole protrude from the sleeve, wherein the opposed terminal sections are configured for grasping in hands of user, positioning the user for lifting the shell and the articles.

2. The debris collection device of claim 1, wherein the shell comprises one or more of nylon, canvas, and elastomer.

3. The debris collection device of claim 1, further including a set of caps, each cap being engaged to an opposed terminus of respective pole, such that each opposed terminus of each pole is capped.

4. The debris collection device of claim 1, further including:
a pair of first creases, each first crease being positioned in a respective opposed end of the shell substantially equally distant from the opposed sides, such that the opposed ends are foldable; and
a second crease positioned in a bottom of the shell substantially equally distant from the opposed sides, such that the bottom is foldable.

5. The debris collection device of claim 4, wherein:
the bottom is arcuate; and
the opposed ends are arcuate proximate to the bottom, such that the shell is substantially U-shaped when viewed from a respective opposed end.

6. The debris collection device of claim 1, further including a pair of cutouts, each cutout being positioned in a respective sleeve substantially equally distant from opposed endpoints of the respective sleeve, wherein the cutout is configured for facilitating insertion of a respective pole through the respective sleeve.

7. A debris collection method, the method comprising the steps of:
providing a debris collection device comprising:
a shell defining an interior space, the shell being flexible, such that the shell is collapsible, the shell having a top, the top being open,
a pair of sleeves engaged singly to and extending along opposed sides of the shell proximate to the top, and
a pair of poles, each pole being selectively insertable into a respective sleeve, such that opposed terminal sections of the pole protrude from the sleeve;
positioning a respective opposed side of the shell on a surface proximate to debris, such that an associated pole is adjacent to the surface and the debris;
stepping on the associated pole;
lifting the other pole to open the top;
maneuvering the debris through the top into the interior space;
grasping the opposed terminal sections; and
lifting and transporting the shell and the debris.

8. A debris collection device comprising:
a shell defining an interior space, the shell being flexible, such that the shell is collapsible, the shell having a top, the top being open, wherein the top is configured for insertion of articles into the interior space, the shell comprising one or more of nylon, canvas, and elastomer;
a pair of sleeves engaged singly to and extending along opposed sides of the shell proximate to the top;
a pair of poles, each pole being selectively insertable into a respective sleeve, such that opposed terminal sections of the pole protrude from the sleeve, wherein the opposed terminal sections are configured for grasping in hands of user, positioning the user for lifting the shell and the articles;
a set of caps, each cap being engaged to an opposed terminus of respective pole, such that each opposed terminus of each pole is capped;
a pair of first creases, each first crease being positioned in a respective opposed end of the shell substantially equally distant from the opposed sides, such that the opposed ends are foldable, the opposed ends being arcuate proximate to the bottom, such that the shell is substantially U-shaped when viewed from a respective opposed end;
a second crease positioned in a bottom of the shell substantially equally distant from the opposed sides, such that the bottom is foldable, the bottom being arcuate; and
a pair of cutouts, each cutout being positioned in a respective sleeve substantially equally distant from opposed endpoints of the respective sleeve, wherein the cutout is configured for facilitating insertion of a respective pole through the respective sleeve.
